(19) United States
(12) Patent Application Publication
(10) Pub. No.: US 2012/0109707 A1
(43) Pub. Date: May 3, 2012

(54) PROVIDING A STATUS INDICATION FOR A PROJECT

(76) Inventors: MARIANNE HICKEY, Bristol (GB); Maher Rahmouni, Bristol (GB); Hiram Trimble Davis, Austin, TX (US)

(21) Appl. No.: 12/913,873

(22) Filed: Oct. 28, 2010

(51) Int. Cl. G06Q 10/00

(52) U.S. Cl. 705/7.23

(57) ABSTRACT

To provide a status indication for a particular project, a rule describing a condition relating to the status indication for the particular project is provided, where the condition is based on a probability of an issue occurring. It is determined that the condition is satisfied using information from selected past projects, and the status indication is selectively set to one of plural states based on the condition being satisfied.

### BACKGROUND

Within an enterprise, such as a company, educational organization, government agency, and so forth, projects are performed as part of the operations of the enterprise. Often, there can be issues relating to a project that may adversely affect performance of the project.

### BRIEF DESCRIPTION OF THE DRAWINGS

Some embodiments are described with respect to the following figures:

FIG. 1 is a flow diagram of a procedure according to some implementations;

FIG. 2 is a block diagram of example components for providing a rule-based status indication, according to some implementations;

FIG. 3 is a block diagram of a probability estimator according to some implementations; and

FIGS. 4 and 5 are block diagrams of example systems incorporating some implementations.

### DETAILED DESCRIPTION

Personnel associated with an enterprise, such as a company, educational organization, government agency, or other organization, can be engaged in performing various projects. A “project” refers to a collection of activities to be performed by an individual or a group of individuals. Examples of projects include a project to provide information technology support, a project related to development of a product or service, a project related to delivery of a product or service, and so forth. As used here, the term “project” can refer to an individual project, or alternatively, to a portfolio of projects.

Traditionally, issues that may adversely affect projects may not be identified early enough to allow for effective actions to be taken to resolve such issues. Examples of issues that may adversely affect projects include cost issues that may cause a project to be over budget, late delivery issues, and/or poor performance issues, and so forth. Such issues can result in monetary and reputation losses to the enterprise, for example. More generally, an “issue” refers to a problem, an event, an occurrence, a state, or some other circumstance that can affect performance of a project.

In some examples, potential late delivery (of a product or service) is often undetected by or hidden from appropriate personnel, and projects can move from a healthy state to a critical state relatively rapidly and without much notice. As a result, appropriate actions may not be taken to resolve issues until a project has reached a critical state, by which time timely resolution of the issues may not be possible. Without advanced warning of issues, management may not be able to take proactive steps for mitigating or preventing issues that can cause projects to achieve target goals.

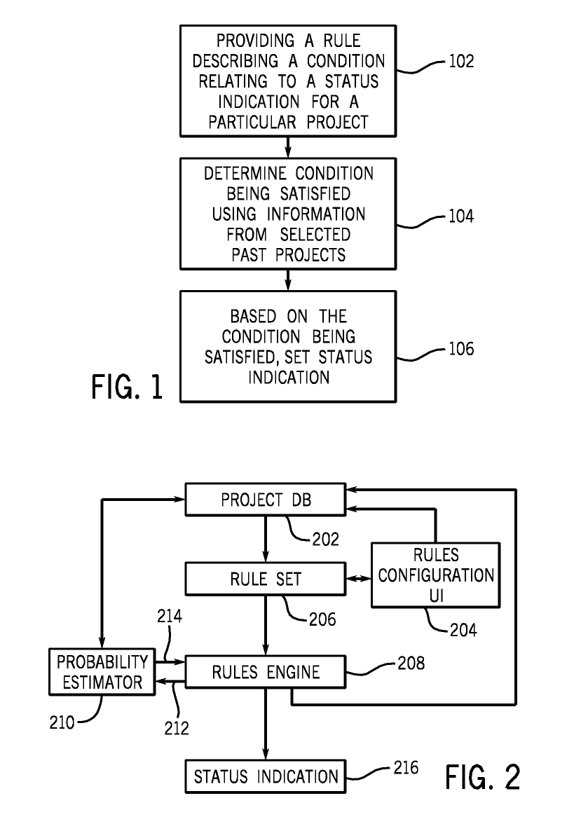

In accordance with some embodiments, early status indications can be generated regarding a project to allow for users (e.g., managers, developers, etc.) to take actions early enough to allow for effective resolution of corresponding issues. FIG. 1 is a flow diagram of a process of providing early status indication regarding a particular project, in accordance with some implementations. The process of FIG. 1 includes providing (at 102) a rule describing a condition relating to a status indication for the particular project, where the condition is based on a probability of an issue occurring. Note that the condition is based on the probability of the issue occurring, rather than the issue actually occurring.

The condition described by the rule can be represented as an expression, where the expression can specify one or multiple metrics associated with the project and a relationship of the one or multiple metrics with respect to one or multiple criteria. The expression can include a logical operator, a conditional operator, or some other type of operator. The operator acts on one or multiple metrics associated with the project. Example project metrics include cost, time, resource, and so forth.

The rule describing the condition that is based on a probability of an issue occurring can be specified by a user, such as a project manager. The rule can be part of a set of rules. The rule can be manually or automatically created or adjusted, or alternatively, the rule can be a default rule provided for a particular project type, organization, industry sector, and so forth.

As examples, the condition can be based on a probability of a project metric (cost, time, resource) being a certain value or within a certain range (e.g., between two thresholds, below a threshold, or above a threshold).

An example syntax of a condition is provided below:

Condition=Expression{LogicalOperator Expression}

where:
LogicalOperator is any logical operator such as AND, OR, etc.
Expression=ProbabilisticExpression, ConditionalExpression or LogicalExpression
ProbabilisticExpression=Probability(ConditionalExpression) ConditionalOperator Value
ConditionalExpression=(Metric ConditionalOperator Value)

Metric is a label, e.g. a type of measurement for projects/portfolios

ConditionalOperator can be >, <, =, >=, <=, <>, or another operator

Value is a value of the metric, or a richer expression e.g. a set or range of values
LogicalExpression=(Expression LogicalOperator Expression)

In other examples, other syntax for specifying the condition of a rule can be used.

Once a condition of a rule is satisfied, then an action specified by the rule can be taken. Note that the action that can be specified by the rule can be an action to generate a status indication. Alternatively, or in addition, the action can be some other action to be taken in response to the condition being satisfied. The action (or actions) to take in response to satisfying a condition can be specified by a user, such as a project manager.

As further depicted in FIG. 1, using information from selected past projects, the process of FIG. 1 determines (at 104) the condition of the rule (provided at 102) being satisfied in the particular project. The selected past projects can be past projects that are similar to the particular project (which is the current or active project).

Based on the condition being satisfied, the process of FIG. 1 selectively sets (at 106) the status indication to one of plural states. Where the condition is deterministic, the plural states may include, for example, a first state indicating that a project is healthy, a second state providing an actual warning (indicating, for example, that an issue has reached a state that is adversely affecting the project) and one or more intermediate states to provide an early warning (to indicate, for example, that an issue that can adversely affect the project has or is about to occur). Where the condition is probabilistic, the plural states may include, for example, a first state indicating that a project's future health state is predicted to be good, a second state providing an early warning (indicating that the project's future health state is likely to be bad, for example, an issue is likely to adversely affect the project) and one or more intermediate states to provide an early warning (to indicate that the project's health state is likely to move to a questionable state, e.g. an issue that can adversely affect the project has a worrying likelihood of occurring). Additionally, a further action can be taken in response to the condition being satisfied.

FIG. 2 is a block diagram of various components of a system according to some implementations. The system of FIG. 2 depicts a project database 202 that stores information relating to various projects, including past projects as well as a current (active) project. FIG. 2 also shows a rules configuration user interface 204, through which a user is able to configure one or multiple rules in a rule set 206 for consideration in determining whether or not a status indication should be provided for an active project that is presently under consideration. The rules configuration user interface 204 can be a graphical user interface in which a user can make selections or enter data for specifying rules for inclusion in the rule set 206.

FIG. 2 also shows a rules engine 208 that operates during execution of a project. The rules engine 208 interprets the rule(s) in the rule set 206 that is (are) associated with an active project. A probability estimator 210 interacts with the rules engine 208 for determining whether a condition of the applicable rule(s) is satisfied, based on a probability of an issue occurring. The rules engine 208 provides (at 212) a conditional expression (specified in the rule set 206) to the probability estimator 210. The conditional expression represents the condition. For example, the conditional expression can have the following form: Metric ConditionalOperator Value (where Metric is a metric that represents the issue of interest, Value represents a threshold or a range, and ConditionalOperator specifies a relationship between Metric and Value that if true means that the corresponding condition is satisfied).

The probability estimator 210 calculates a probability value for a probability of an issue specified in the conditional expression. The probability value calculated by the probability estimator 210 uses information from past (similar) projects to calculate the probability value. The probability value is calculated by mining data from other projects (historical or active projects) within the project database 202. The probability value can also be calculated based on data from the active project itself. The probability estimator 210 returns (at 214) the calculated probability value to the rules engine 208.

Based on the probability returned by the probability estimator 210, the rules engine 208 determines whether a corresponding action associated with the rule is to be executed. The action can include providing a status indication 216 (e.g., report, e-mail, etc.) based on the returned probability from the probability estimator 210.

Although the foregoing refers to just one conditional expression being sent (at 212) from the rules engine 208 to the probability estimator 210, and one probability value returned (at 214) from the probability estimator 210 to the rules engine 208, it is noted that there can be multiple conditional expressions and probability values exchanged between the rules engine 208 and probability estimator 210. Also, although the rules engine 208 and probability estimator 210 are depicted as separate modules, in other implementations, the rules engine 208 and the probability estimator 210 can be integrated into one module.

If multiple rules (in the rule set 206) for the active project have to be processed, the rules engine 208 evaluates each rule in turn, starting from a first rule and continuing on until each applicable rule has been evaluated. If a rule is triggered (a condition has been satisfied), then the corresponding action is taken.

The following provides an example to illustrate some implementations. For a given example project, a tolerance for a particular project stage (a stage from among multiple different stages of the project) is such that the duration of the particular stage should not overrun a target time period by more than 20% and the project should remain adequately resourced throughout (supplied with adequate personnel and/or equipment). An example conditional expression that can be specified in a corresponding rule can be as follows. If the probability of a 20% time overrun is greater than a predefined percentage, or the probability of resources being insufficient is greater than a predefined percentage in a given time window of the project, then generate an early warning alarm. Note that the condition is based on a probability of project metric exceeding a tolerance (e.g. in the near future), and not actually exceeding such tolerance, so that the alert generated is an early warning.

Another example rule is set forth below:
If the probability of overspend <=2%, AND/OR <other conditions> . . . Then portfolio is predicted to be healthy, generate a green signal;
If the probability of overspend >2% AND <5%, AND/OR <other conditions> . . . Then generate an amber early warning signal;
If the probability of overspend >=5%, AND/OR <other conditions> . . . Then generate a red early warning signal.

The rule above specifies three conditional expressions: (1) the probability of overspend <=2%, AND/OR <other conditions>; (2) the probability of overspend >2% AND <5%, AND/OR <other conditions>; and (3) the probability of overspend >=5%, AND/OR <other conditions>.

Alternatively, instead of being referred to as three conditional expressions, the collection of the relationships of “probability of overspend” to corresponding thresholds (<=2%, >2% AND <5%, >=5%) can be considered as one conditional expression (or condition). Thus, as used here, a “conditional expression” or “condition” refers to expressed relationship(s) between a probability of an issue with respect to one or multiple thresholds (or other criteria).

The rules engine 208, in addition to processing rule(s) associated with a particular project, can also update the project database 202. The rules engine 208 can update the project database 202 with information regarding issues that have occurred in the active project. Such updated information regarding issues that have occurred in the active project can be used in determining probabilities of issues occurring in subsequently processed projects.

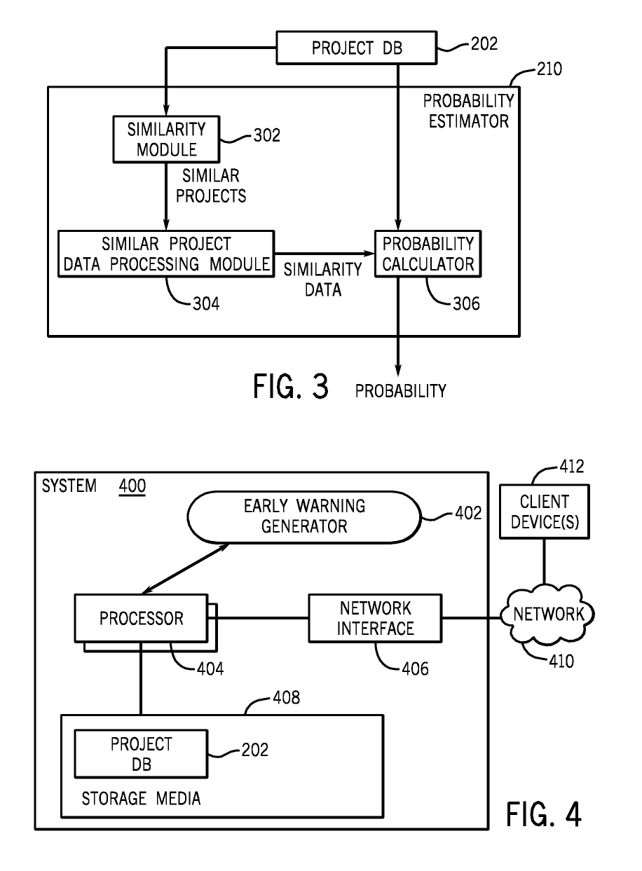

FIG. 3 illustrates example components of the probability estimator 210 of FIG. 2, according to further implementations. Note that the arrangement of FIG. 3 (and the description below regarding the FIG. 3 arrangement) refers to some implementations—it is noted that other arrangements can be used in other implementations. For each project, metrics m₁, m₂, . . . m_{g} (where g is an integer representing the number of metrics used for each project) can be used to represent characteristics of a project at time intervals over the project's lifetime. For example, one of the metrics can be the difference between the planned and actual time duration (to indicate time over-run). Another metric can be a budget metric (to indicate cost over-run).

The total time of a project can be split into a number of time periods {t₁, t₂, . . . t_{f}} each of a particular duration (e.g., hour, day, week, month, etc.), which is configurable by a user, where time period t₁ is the first time period of the project and time period t_{f} is the last time period of the project. Note that f can be different for different projects, as project durations may vary.

For every past or active project p (where p can be an individual project or a portfolio of projects) in the database 202, and for each metric mₓ (x=1 to g, where g represents the number of metrics for each project), a vector Mₓₚ, is created where the vector Mₓₚ, contains values for mₓ for each of the f time periods when project p was in operation. The vector Mₓₚ can be represented as follows in some examples:

Mₓₚ=(m_{x,p,t=1}, m_{x,p,t=2} . . . , m_{x,p,t=f}). (Eq. 1)

For an active project pₐ that is currently in a given time period, t_{c} (where c ranges from 1 to f), time periods going forwards {t_{c}, t_{c+1}, t_{c+2}, . . . , t_{c+j}} are considered, where such time periods are from the current time period t_{c} to a future time period t_{c+j}, where c+j is the last time period. In some examples, each time period t_{z} (z=c, . . . , c+j) is associated with a corresponding time period weight, w_{z}, where the weight w_{z} is larger for closer time periods (closed to t_{c}) to favor metric values in the near future over those in the more distant future, and where the time period weight w_{z} is smaller for farther time periods (farther away from t_{c}). In other words, the time period weights w_{z} vary according to time proximity of a future time interval to a current time interval of the particular project under evaluation

These weights w_{z} are represented by a vector W:

W=(w₀, w₁, . . . , w_{J}),

where:
J is the number of time periods from time period c until the last time period of the project,
w₀ is the weight for t_{c}, w₁ is the weight for t_{c+1}, and so on, w₀>w₁> . . . >w_{J},
e.g.: w_{z}=1/(1+z).

As further depicted in FIG. 3, the probability estimator 210 includes a similarity module 302 for identifying projects from the project database 202 that are similar to the active project based at least on one criterion. In some examples, the similarity module 302 can implement similarity mechanisms as described in PCT Appl. No. PCT/US10/30518, entitled “Method and System for Comparing and Locating Projects,” filed Apr. 9, 2010, for finding similar projects. The project similarity techniques of PCT/US10/30518 extract features of projects being compared, where the features can be extracted from project profiles. The features for the projects are provided to corresponding feature comparators, which output respective feature-similarity values. The outputs from feature comparators are weighted and aggregated by a feature-similarity aggregator(s) to produce a final project-similarity value, which is used to provide a measure of the relative similarity of the compared projects. Further details regarding such project similarity mechanisms are described in PCT/US10/30518. In other implementations, other techniques for finding similar projects can be used by the similarity module 302.

Each similar project, pₛ, is associated with a project similarity weight, vₛ, which is larger for projects with a higher degree of similarity to the current project (in other words, the weight vₛ has a higher value for a more similar project and a lower value for a less similar project). This weight is derived from information provided by the similarity module 302.
0=<vₛ<=1, where s=1 . . . D, where D is the number of similar projects identified by the similarity module 302.

The probability estimator 210 further includes a similar project data processing module 304 to process similar project data from the identified similar projects. For each similar project, pₛ, the similar project data processing module 304 ensures that the project pₛ is genuinely similar based on user feedback. For example, a project pₛ can be identified to a user, such as through a user interface, to prompt the user to indicate whether or not the project pₛ is in fact similar. Confirming that a project pₛ is similar can improve the accuracy of the system.

The probability estimator 210 determines a time period tᵢ that represents a similar stage in similar project pₛ as the current time period t_{c} of the active project pₐ. In some examples, if projects pₐ and pₛ have different durations, one way to identify tᵢ is by setting i as follows:

$$i = \frac{{cf}_{s}}{{f}_{a}} , \qquad ( Eq . 2 )$$

where fₐ: number of planned time periods in the active project pₐ, and fₛ: number of time periods in the similar project pₛ.

Consider a rule set for project pₐ. For each conditional expression, e, in the rule set, the probability estimator 210 finds the metric, mₓ, upon which the expression e is based, and the corresponding vector of values Mₓₛ, for similar project pₛ (see Eq. 1). For each time period tₖ, the corresponding metric value m_{x,s,t=k} is evaluated according to the conditional expression e and the result (condition satisfied or not satisfied) is assigned to u_{e,s,z}. In some examples, the results are compiled in the vector Uₑₛ:

Uₑₛ=(u_{e,s,z=0}, u_{e,s,z=1}, . . . , u_{e,s,z=J}) (Eq. 3)

where:
u_{e,s,z}=1 if conditional expression e evaluates to true
u_{e,s,z}=0 if conditional expression e evaluates to false
k=i, . . . , i+J and z=k−i.

Given the data on all similar projects to project pₐ, the probability calculator 306 in the probability estimator 210 evaluates the probability of a given conditional expression e from the rule set, such as according to the following:

$$Probability ( e ) = \frac{{\sum }_{z = 0}^{J} {\sum }_{s = 1}^{D} {w}_{z} {v}_{x} {u}_{e , s , z}}{{\sum }_{z = 0}^{J} {w}_{z} {\sum }_{s = 1}^{D} {v}_{s}} . \qquad ( Eq . 4 )$$

In other implementations, probability values can be calculated using other formulas. Generally, the probability value for a conditional expression e can be based on a weighted sum of true/false results (u_{e,s,z}) (weighted according to time period weights w_{z} and project similar weights vₛ). This weighted sum can be normalized to the product of the sums of w_{z} and vₛ, as in Eq. 4 above. In other examples, instead of weighted sums, other types of weighted aggregates can be used.

By producing a status indication (216 in FIG. 2) according to a condition based on the probability of an issue occurring (rather than the issue actually occurring), an early status indication can be generated to allow more time for personnel to resolve the issue prior to the issue becoming critical. Projects can be associated with many metrics that have to be tracked to ensure their health. Using techniques or mechanisms according to some implementations, an efficient and effective capability is added to provide status indications based on the various metrics.

FIG. 4 depicts an example system 400, which can be implemented as a single computer node or multiple computer nodes in a distributed environment. The system 400 includes an early warning generator 402, which can be implemented with the components of FIGS. 2 and/or 3, for example.

The early warning generator 402 can be implemented as machine-readable instructions executable on a processor (or multiple processors) 404. The processor(s) 404 is (are) connected to a storage media 408, which stores the project database 202. The system 400 also includes a network interface 406 to allow the system 400 to communicate over a network 410 with client device(s) 412, such as to report early warnings produced according to some implementations.

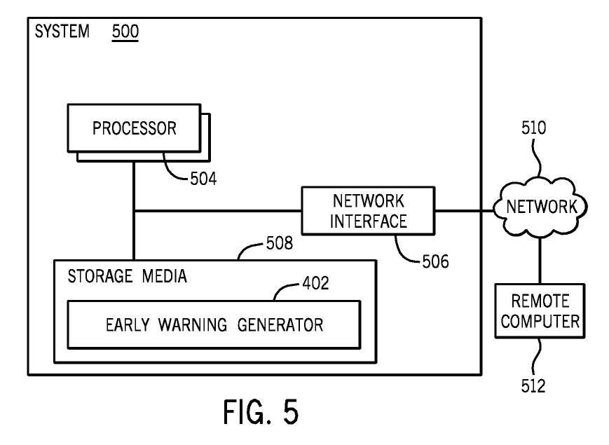

In alternative implementations as depicted in FIG. 5, the early warning generator 402 can be downloaded to a remote computer (512) for execution from a system 500, where the early warning generator 402 is stored in a storage media 508. The system 500 includes one or multiple processors 504 and a network interface 506 to allow the early warning generator 402 to be downloaded over the network 510 to the remote computer 512 for execution at the remote computer 512 to perform tasks according to implementations discussed herein.

The processor 404 or 504 can include a microprocessor, microcontroller, processor module or subsystem, programmable integrated circuit, programmable gate array, or another control or computing device.

Data and instructions are stored in respective storage devices, which are implemented as one or more computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method of providing a status indication for a particular project, comprising:
providing, in a system having a processor, a rule describing a condition relating to the status indication for the particular project, wherein the condition is based on a probability of an issue occurring;
determining, by the system, that the condition is satisfied using information from selected past projects; and
selectively setting the status indication to one of plural states based on the condition being satisfied.

2. The method of claim 1, wherein the condition specifies at least one threshold, and wherein selectively setting the status indication to one of plural states comprises:
setting the status indication to a first of the plural states in response to the probability having a first relationship to the at least one threshold; and
setting the status indication to a second of the plural states in response to the probability having a second, different relationship to the at least one threshold.

3. The method of claim 2, wherein the first state corresponds to a healthy state of the particular project, and the second state corresponds to a warning state relating to the particular project.

4. The method of claim 1, wherein the probability of the issue occurring as specified by the condition is indicated by a probability of at least one metric of the particular project satisfying at least one criterion.

5. The method of claim 1, further comprising:
identifying the selected past projects from a set of past projects, wherein the selected past projects are projects identified as being similar to the particular project based on at least one criterion.

6. The method of claim 5, wherein determining that the condition is satisfied uses information in the selected past projects and in the particular project.

7. The method of claim 6, further comprising:
dividing each of the particular project and selected past projects into plural time intervals;
specifying, for each of the particular project and selected past projects, values of the at least one metric in the corresponding time intervals,
wherein determining that the condition is satisfied is based on evaluating each of the values of the at least one metric to determine whether the condition is satisfied in each corresponding one of the time intervals.

8. The method of claim 7, further comprising:
assigning weights to each of the selected past projects, wherein the weights vary depending upon similarity of the selected past projects to the particular project,
wherein determining that the condition is satisfied is further based on the weights.

9. The method of claim 8, wherein determining that the condition is satisfied comprises determining whether the probability of the issue satisfies at least one criterion, the method further comprising calculating the probability based on the weights.

10. The method of claim 7, further comprising:
for a given time interval in the particular project, assigning weights to at least some other time intervals in the particular project, wherein the weights differ depending upon time proximity of the other time intervals to the given time interval,
wherein determining that the condition is satisfied is further based on the weights.

11. A system comprising:
a storage media to store a set of past projects; and
at least one processor to:
provide a rule describing a condition relating to provision of a status indication for an active project, wherein the condition is based on a probability relating to at least one metric of the active project;
calculate the probability relating to the at least one project using values of the at least one metric from a selected subset of the set of past projects; and
determine whether or not to generate the status indication for the active project based on the calculated probability.

12. The system of claim 11, wherein the condition specifies a relation of the probability to at least one criterion, wherein the at least one processor is to generate the status indication based on the calculated probability satisfying the relation to the at least one criterion.

13. The system of claim 12, wherein the at least one criterion comprises at least one threshold.

14. The system of claim 12, wherein the generated status indication is an early warning indication.

15. The system of claim 12, wherein the condition is represented as a conditional expression, and wherein calculation of the probability comprises:
evaluating the conditional expression for each of the selected subset of past projects and store a corresponding result; and
aggregate the results to compute the probability.

16. The system of claim 15, wherein aggregation of the results comprises computing a weighted sum of the results, wherein the results include a first value for the conditional expression evaluating to true, and a second value for the conditional expression evaluating to false.

17. The system of claim 15, wherein the selected subset of past projects comprises a selected subset of similar past projects based on at least one criterion.

18. An article comprising at least one computer-readable storage mediums storing instructions that upon execution cause a system having a processor to:
provide a rule describing a condition relating to a status indication for a particular project, wherein the condition is based on a probability of an issue occurring;
calculate the probability using information from past projects;
determine, based on the calculated probability, whether the condition is satisfied; and
selectively set the status indication to one of plural states based on the condition being satisfied

19. The article of claim 18, wherein the information from the past projects includes information from past projects identified as similar projects to the particular project.
